(19) United States
(12) Patent Application Publication
(10) Pub. No.: US 2026/0362208 A1
(43) Pub. Date: Nov. 12, 2026

(54) METHOD FOR REPORTING CHANNEL STATE INFORMATION REPORT, AND DEVICE

(71) Applicant: GUANGDONG OPPO MOBILE TELECOMMUNICATIONS CORP., LTD., Dongguan (CN)

(72) Inventors: Yi ZHANG, Dongguan (CN); Jing XU, Dongguan (CN)

(21) Appl. No.: 19/722,788

(22) Filed: Jun. 27, 2026

Related U.S. Application Data
(63) Continuation of application No. PCT/CN2024/092445, filed on May 10, 2024.

(51) Int. Cl. H04W 24/10; H04L 5/14; H04W 72/0446

(52) U.S. Cl. CPC H04W 24/10; H04L 5/14; H04W 72/0446

(57) ABSTRACT

Provided is a method for reporting a channel state information report. The method is performed by a terminal device, and the method includes: receiving a first configuration from a network device, wherein the first configuration is used for the terminal device to determine a subband for which channel state information needs to be reported in the channel state information report; and reporting the channel state information report.

### CROSS-REFERENCE TO RELATED APPLICATION

This application is a continuation of International Application No. PCT/CN2024/092445, filed May 10, 2024, the entire disclosure of which is incorporated herein by reference.

### TECHNICAL FIELD

The present disclosure relates to the technical field of communications, and particularly to a method for reporting a channel state information report, and an apparatus, a device, a medium, and a program product therefor.

### RELATED ART

Subband Full Duplex (SBFD) technology refers to a technology that enables simultaneous transmission and reception of data on different subbands within the same time-domain resource, where the different subbands include at least one of an uplink subband, a downlink subband, or a guard band.

### SUMMARY

The present disclosure provides a method for reporting a channel state information report, and an apparatus, a device, a medium, and a program product therefor. The technical solutions include at least the following.

According to an aspect of embodiments of the present disclosure, a method for reporting a channel state information report is provided, which is performed by a terminal device and includes: receiving a first configuration from a network device, wherein the first configuration is used for the terminal device to determine a subband for which channel state information needs to be reported in the channel state information report; and reporting the channel state information report.

According to another aspect of embodiments of the present disclosure, a method for receiving a channel state information report is provided, which is performed by a network device and includes: transmitting a first configuration, wherein the first configuration is used for a terminal device to determine a subband for which channel state information needs to be reported in the channel state information report; an receiving the channel state information report.

According to another aspect of embodiments of the present disclosure, an apparatus for reporting a channel state information report is provided, which includes: a receiving module, configured to receive a first configuration from a network device, wherein the first configuration is used for the apparatus for reporting the channel state information report to determine a subband for which channel state information needs to be reported in the channel state information report; and a transmitting module, configured to report the channel state information report.

According to another aspect of embodiments of the present disclosure, an apparatus for receiving a channel state information report is provided, which includes: a transmitting module, configured to transmit a first configuration, wherein the first configuration is used for a terminal device to determine a subband for which channel state information needs to be reported in the channel state information report; and a receiving module, configured to receive the channel state information report.

According to another aspect of the embodiments of the present disclosure, a terminal device is provided, which includes: a processor; a transceiver connected to the processor; and a memory configured to store one or more executable instructions of the processor; wherein the processor is configured to load and execute the one or more executable instructions to cause the terminal device to perform the method for reporting a channel state information report as described in the above aspects.

According to another aspect of the embodiments of the present disclosure, a network device is provided, which includes: a processor; a transceiver connected to the processor; and a memory for storing one or more executable instructions of the processor; wherein the processor is configured to load and execute the one or more executable instructions to cause the network device to perform the method for receiving a channel state information report as described in the above aspects.

According to another aspect of the embodiments of the present disclosure, a computer-readable storage medium is provided. The computer-readable storage medium stores at least one program, which when loaded and executed by a processor, cause the processor to perform the method for reporting a channel state information report or the method for receiving a channel state information report as described in the above aspects.

According to another aspect of embodiments of the present disclosure, a chip is provided, which includes programmable logic circuitry and/or one or more program instructions. The chip, when running on a terminal device or a network device, causes the terminal device or the network device to perform the method for reporting a channel state information report or the method for receiving a channel state information report as described in the above aspects.

According to another aspect of embodiments of the present disclosure, a computer program product or computer program is provided, which includes one or more computer instructions stored in a computer-readable storage medium. The one or more computer instructions, when read from the computer-readable storage medium and executed by a processor, cause the processor to perform the method for reporting a channel state information report or the method for receiving a channel state information report as described in the above aspects.

### BRIEF DESCRIPTION OF DRAWINGS

For clearer descriptions of the technical solutions in the embodiments of the present disclosure, the following briefly describes the accompanying drawings required for describing the embodiments. Apparently, the accompanying drawings in the following description illustrate merely some embodiments of the present disclosure, and those of ordinary skill in the art can still derive other drawings from these accompanying drawings without creative efforts.

FIG. 1 illustrates a schematic diagram of SBFD according to the related art;

FIG. 2 illustrates a schematic diagram of a mobile communication system according to some embodiments of the present disclosure;

FIG. 3 illustrates a schematic diagram of a method for reporting a channel state information report according to some embodiments of the present disclosure;

FIG. 4 illustrates a flowchart of a method for reporting a channel state information report according to some embodiments of the present disclosure;

FIG. 5 illustrates a flowchart of a method for receiving a channel state information report according to some embodiments of the present disclosure;

FIG. 6 illustrates a block diagram of an apparatus for reporting a channel state information report according to some embodiments of the present disclosure;

FIG. 7 illustrates a block diagram of an apparatus for receiving a channel state information report according to some embodiments of the present disclosure;

FIG. 8 illustrates a schematic structural diagram of a terminal device according to some embodiments of the present disclosure; and

FIG. 9 shows a schematic structural diagram of a network device according to some embodiments of the present disclosure.

### DETAILED DESCRIPTION

For clearer descriptions of the objectives, technical solutions, and advantages of the present disclosure, embodiments of the present disclosure are further described in detail hereinafter with reference to the accompanying drawings. Exemplary embodiments are described in detail, with examples shown in the accompanying drawings. When the following description refers to the drawings, unless otherwise indicated, the same numerals in different drawings represent the same or similar elements. The implementations described in the following exemplary embodiments do not represent all implementations consistent with the present disclosure. Instead, they are merely examples of apparatus and methods consistent with some aspects of the present disclosure as detailed in the appended claims.

The terms used in the present disclosure are solely for the purpose of describing specific embodiments and are not intended to limit the present disclosure. The use of the singular forms “a,” “an,” “the,” and “this” in the present disclosure and the appended claims is also intended to include the plural form, unless the context clearly indicates otherwise. It should also be understood that the term “and/or” used herein refers to and includes any or all possible combinations of one or more associated listed items.

It should be understood that although the terms “first,” “second,” “third,” and the like may be used herein to describe various pieces of information, such information should not be limited to these terms. These terms are only used to distinguish between pieces of information of the same type. For example, first information may also be referred to as second information, and similarly, second information may also be referred to as first information, without departing from the scope of the present disclosure. The word “if,” as used herein, may be interpreted as “in a case where,” “when,” or “in response to determining that,” depending on the context.

The technical solutions described in some embodiments of the present disclosure can be applied to various communication systems, such as Long Term Evolution (LTE) systems, Advanced Long Term Evolution (LTE-A) systems, New Radio (NR) systems, evolved systems of NR systems, LTE-based access to unlicensed spectrum (LTE-U) systems, NR-based access to unlicensed spectrum (NR-U) systems, Non-Terrestrial Networks (NTN) systems, Universal Mobile Telecommunication System (UMTS), Wireless Local Area Networks (WLAN), Wireless Fidelity (WiFi), 5th Generation (5G) systems, cellular Internet of Things (IoT) systems, cellular passive IoT systems, and can also be applied to subsequent evolved systems of 5G NR systems, as well as 6G and subsequent evolved systems.

It should be understood that in some embodiments of the present disclosure, “5G” may also be referred to as “5G NR” or “NR”.

It should be understood that in the description of embodiments of the present disclosure, the term “correspond” can indicate a direct or indirect corresponding relationship between two items, or indicates an associated relationship between two items; and also indicates relationships such as indicating and being indicated, or configuring and being configured.

In the embodiments of the present disclosure, “predefinition” can be achieved by pre-storing corresponding codes, tables, or other means that can be used to indicate relevant information in devices (e.g., including terminal devices and network devices). The specific implementation method is not limited in the present disclosure. For example, predefinition can refer to what is defined in a protocol.

In the embodiments of the present disclosure, the term “protocol” may refer to a standard protocol in the communication field, for example, including the LTE protocol, the NR protocol, and related protocols applied in the future communication systems, which is not limited in the present disclosure.

Next, channel state information (CSI) report is introduced as follows.

CSI reporting supports wideband Precoding Matrix Indicator (PMI) or Channel Quality Indicator (CQI) reporting, as well as subband PMI or CQI reporting. In the frequency domain, each Bandwidth Part (BWP) is divided into multiple subbands, with each subband size defined as

$${N}_{PRB}^{SB}$$

consecutive Physical Resource Blocks (PRBs). The relevant standards define two candidate values for subband size based on the range of BWP size (as shown in Table 1), and the network device indicates one of the two candidate values through Radio Resource Control (RRC) signaling.

TABLE 1

| BWP | Subband |
|---|---|
| (PRBs) | size (PRBs) |
| 24-72 | 4, 8 |
| 73-144 | 8, 16 |
| 145-275 | 16, 32 |

For the division of a CSI reporting subband within a BWP, the rule is as follows: the first subband size is

$${N}_{PRB}^{SB} - ( {N}_{BWP , i}^{start} mod {N}_{PRB}^{SB} ) ; if ( {N}_{BWP , i}^{start} + {N}_{BWP , i}^{s i z e} ) mod {N}_{PRB}^{SB} \neq 0 ,$$

then the last subband size is

$$( {N}_{BWP , i}^{start} + {N}_{BWP , i}^{s i z e} ) mod {N}_{PRB}^{SB} ; if ( {N}_{BWP , i}^{start} + {N}_{BWP , i}^{s i z e} ) mod {N}_{PRB}^{SB} = 0 ,$$

then the last subband size is

$${N}_{PRB}^{SB} ,$$

where

$${N}_{BWP , i}^{start}$$

is the start position of the BWP in the frequency domain, and

$${N}_{BWP , i}^{s i z e}$$

is the size of the BWP.

The network device may configure the reporting of PMI or CQI report as wideband reporting or subband reporting, and if subband reporting is configured, the network device may configure the subbands for which CSI is to be reported.

The CQI reporting for each subband is either a 2-bit differential CQI reporting or a 4-bit CQI reporting, configured by the first higher-layer parameter cqi-BitsPerSubband. If the network device does not configure this first higher-layer parameter, then for each subband configured to require reporting of CSI measurement information, a 2-bit differential CQI is reported.

The differential CQI is defined as sub-band Offset level(s)=sub-band CQI index(s)-wideband CQI index.

The sub-band offset level is calculated as the sub-band CQI index minus the wideband CQI index. The mapping relationship between the sub-band differential CQI value and the sub-band Offset level is shown in Table 2.

TABLE 2

| Sub-band | |
|---|---|
| differential | Sub-band |
| CQI value | Offset level |
| 0 | 0 |
| 1 | 1 |
| 2 | ≥2 |
| 3 | ≤−1 |

If the network device has configured the first higher-layer parameter, then for each subband configured to require reporting of CSI measurement information, a 4-bit CQI is reported. Next, SBFD is introduced as follows.

To overcome the issues in Time Division Duplexing (TDD) technology, such as weak uplink (UL) coverage, high UL latency, and insufficient UL capacity due to limited UL resource allocation, the SBFD technology is proposed. SBFD technology refers to the capability of simultaneously transmitting and receiving data on different subbands within the same subframe, slot, or symbol. SBFD technology is primarily employed on the network device side, while the User Equipment (UE) side remains unchanged, meaning that only data is transmitted or received within the same subframe, slot, or symbol. SBFD technology may also be referred to as Cross Division Duplex (XDD) technology.

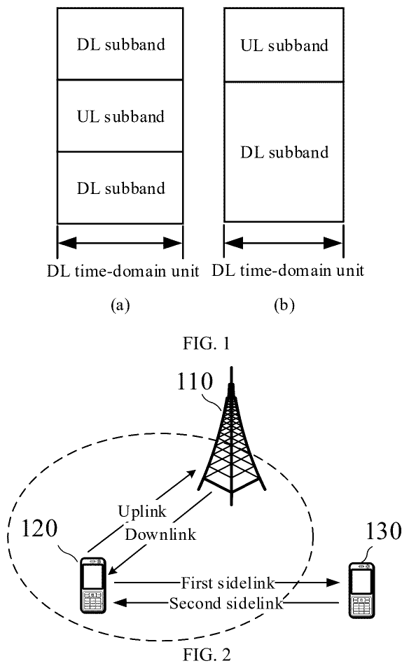

Illustratively, the SBFD technology, as shown in FIG. 1, configures a part of the frequency-domain resource corresponding to a downlink (DL) time-domain unit as an UL subband. As shown in FIG. 1(a), the middle subband of the frequency-domain resource corresponding to a DL time-domain unit is configured as an UL subband, i.e., the DL subband (D) and the UL subband (U) are in the form of DUD. Alternatively, as shown in FIG. 1(b), the upper subband of the frequency-domain resource corresponding to a DL time-domain unit is configured as an UL subband, i.e., the DL subband (D) and the UL subband (U) are in the form of DU. A guard band may exist between the UL subband and the DL subband.

In addition, for terminal devices that support the SBFD feature, whether to use a single CSI report configuration (CSI-ReportConfig) to support both SBFD and non-SBFD symbols, or to use different CSI report configurations for SBFD and non-SBFD symbols respectively, as well as whether to associate with one CSI reference signal (CSI-RS) resource or two CSI-RS resources, are also open questions. The options are as follows.

For SBFD-aware UEs, study the following options for CSI report associated with periodic/semi-persistent CSI-RS, at least, across SBFD symbols and non-SBFD symbols in different slots (each CSI-RS resource within a slot has either all SBFD or all non-SBFD symbols): Option 1: separate CSI reporting for SBFD symbols and non-SBFD symbols;

Option 2: same CSI reporting for SBFD symbols and non-SBFD symbols.

For SBFD-aware UEs, study the following options for CSI report associated with periodic/semi-persistent CSI-RS in case the periodicity is such that CSI-RS instances occur in both SBFD and non-SBFD symbols:

Option 1: two CSI-ReportConfigs, where one is associated with SBFD symbols and the other is associated with non-SBFD symbols.

Option 1-1: One CSI-ReportConfig is associated with a CSI-RS restricted to SBFD symbols only and the second CSI-ReportConfig is associated with a second CSI-RS restricted to non-SBFD symbols only.

Option 1-2: Both CSI-ReportConfigs are associated with the same CSI-RS. The CSI report associated with one CSI-ReportConfig is derived based on CSI-RS instances in SBFD symbols only. The CSI report associated with the second CSI-ReportConfig is derived based on CSI-RS instances in non-SBFD symbols only.

Option 2: one CSI-ReportConfig associated with both SBFD symbols and non-SBFD symbols.

Option 2-1: One CSI-ReportConfig is associated with two CSI-RSs which are restricted to SBFD symbols and non-SBFD symbols respectively. Separate CSI measurements are derived based on the first and second CSI-RSs respectively.

Option 2-2: One CSI-ReportConfig is associated with one CSI-RS. The CSI report is derived based on CSI-RS which can be in SBFD symbols or non-SBFD symbols in different time instances.

Note: Whether the CSI-RS resource can be used for SBFD and non-SBFD symbols may depend on, e.g., gNB implementation of same/different antenna configuration in both symbols.

Option 1-1 can be supported according to existing specification by gNB configuration of appropriate periodicities to ensure that the CSI-RS associated with each CSI-ReportConfig is confined to either SBFD symbols or non-SBFD symbols only. But it may restrict the gNB configuration flexibility and enhancements can be considered by additional indication or rules to determine the CSI-RS is valid within one symbol type and is invalid in the other symbol type.

Option 2-2 can be supported according to existing specification to configure measurement restriction so that UE would not average CSI measurements across SBFD and non-SBFD symbols.

FIG. 2 illustrates a schematic diagram of a mobile communication system according to some embodiments of the present disclosure. The mobile communication system includes a network device 110 and a terminal device 120, and may or may not include a terminal device 130, which is not limited in the present disclosure.

The network device 110 in the present disclosure provides wireless communication functions, and includes but is not limited to: an Evolved Node B (eNB), a Radio Network Controller (RNC), a Node B (NB), a Base Station Controller (BSC), a Base Transceiver Station (BTS), a home base station (e.g., a home eNB, or a home NB (HNB)), a BaseBand Unit (BBU), an Access Point (AP) in a Wireless Fidelity (Wi-Fi) system, a wireless relay node, a wireless backhaul node, a Transmission Point (TP), or a Transmission and Reception Point (TRP), etc. It can also be a Next Generation Node B (gNB) or a Transmission Point (TRP or TP) in the 5G mobile communication system, or one or a group of antenna panels (including multiple antenna panels) of a base station in the 5G system, or a network node constituting a gNB or TP, such as a Baseband Unit (BBU) or Distributed Unit (DU), etc. It can also be a base station in the Beyond 5G (B5G) or 6th Generation (6G) mobile communication system, or Core Network (CN), Fronthaul, Backhaul, Radio Access Network (RAN), network slicing, etc., or a serving cell, a Primary Cell (PCell), a Primary Secondary Cell (PSCell), a Special Cell (SpCell), Secondary Cell (SCell), a neighbor cell, etc. of a terminal device.

In the present disclosure, the terminal device 120 is also referred to as a UE, an access terminal device, a subscriber unit, a subscriber station, a mobile station, a remote station, a remote terminal device, a mobile device, a user terminal device, a terminal, a wireless communication device, a user agent, or a user apparatus. The terminal device includes but is not limited to: handheld devices, wearable devices, in-vehicle devices, and IoT devices, such as mobile phones, tablet computers, e-book readers, laptop computers, desktop computers, televisions, game consoles, Mobile Internet Devices (MID), Augmented Reality (AR) terminal devices, Virtual Reality (VR) terminal devices, Mixed Reality (MR) terminal devices, Extended Reality (XR) terminal devices, Baffle Reality (BR) terminal devices, Cinematic Reality (CR) terminal devices, Deceive Reality (DR) terminal devices, wearable devices, gamepads, electronic tags, controllers, wireless terminal devices in industrial control, self-driving, remote medical, smart grid, transportation safety, smart city, smart home, remote medical surgery, cellular phones, cordless phones, Session Initiation Protocol (SIP) phones, Wireless Local Loop (WLL) stations, Personal Digital Assistants (PDA), Set-Top Boxes (STB), Customer Premise Equipment (CPE), etc.

In some embodiments, the network device 110 and the terminal device 120 communicate with each other via an air interface technology, such as a Uu interface.

Illustratively, there are two communication scenarios between the network device 110 and the terminal device 120: an uplink communication scenario and a downlink communication scenario. Uplink communication, also known as uplink transmission, refers to transmitting signals or data to the network device 110; downlink communication, also known as downlink transmission, refers to transmitting signals or data to the terminal device 120.

In some embodiments, the terminal device 120 and the terminal device 130 communicate with each other via an air interface technology, such as a PC5 interface.

Illustratively, there are two communication scenarios between terminal device 120 and terminal device 130: a first sidelink communication scenario and a second sidelink communication scenario. The first sidelink communication refers to terminal device 120 transmitting signals to terminal device 130; the second sidelink communication refers to terminal device 130 transmitting signals to terminal device 120.

In some embodiments, both the terminal device 120 and the terminal device 130 are within the network coverage and located in the same cell, or both the terminal device 120 and the terminal device 130 are within the network coverage but located in different cells, or the terminal device 120 is within the network coverage but the terminal device 130 is outside the network coverage.

In some embodiments of the present disclosure, “NR” may also be referred to as a 5G NR system or a 5G system. The 5G mobile communication system may include Non-Stand Alone (NSA) and/or Stand Alone (SA) networking.

The technical solutions according to the embodiments of the present disclosure can also be applied to Machine Type Communication (MTC), Long Term Evaluation-Machine (LTE-M), Device to Device (D2D) networks, Machine to Machine (M2M) networks, IoT networks, or other networks. IoT networks can include, for example, the Internet of Vehicles (IoV). The communication modes in the IoV system are collectively referred to as Vehicle to X (V2X, where X can represent anything), such as Vehicle to Vehicle (V2V) communication, Vehicle to Infrastructure (V2I) communication, Vehicle to Pedestrian (V2P) communication, or Vehicle to Network (V2N) communication.

The mobile communication system according to embodiments of the present disclosure can be applied to, but is not limited to, at least one of: uplink communication scenario, downlink communication scenario, or sidelink communication scenario.

SBFD technology refers to a technology that enables simultaneous transmission and reception of data on different subbands within the same time-domain resource, wherein different subbands include at least one of an uplink subband, a downlink subband, or a guard band. However, if there are multiple CSI reporting subbands with frequency-domain bandwidths corresponding to different subbands, whether to report channel state information for different CSI reporting subbands is an urgent technical problem to be addressed.

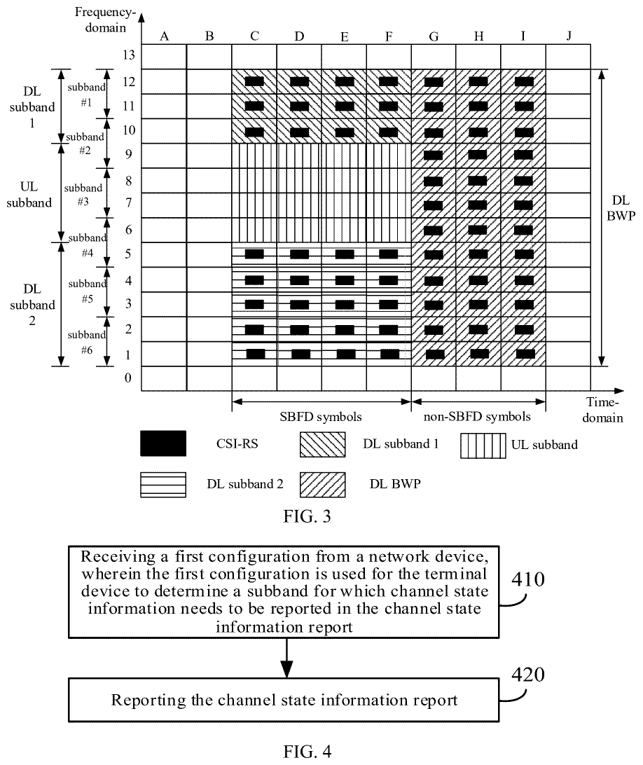

To address the aforementioned problem, embodiments of the present disclosure provide a method for reporting a channel state information report. FIG. 3 illustrates a schematic diagram of the method for reporting a channel state information report according to some embodiments of the present disclosure. In the diagram, black squares represent CSI-RS, squares filled with diagonal lines from top left to bottom right represent DL subband 1, squares filled with vertical lines represent UL subband, squares filled with horizontal lines represent DL subband 2, and squares filled with diagonal lines from top right to bottom left represent DL BWP. The frequency domain bandwidth corresponding to the SBFD symbol includes DL subband 1, UL subband, and DL subband 2, while the frequency domain bandwidth corresponding to the non-SBFD symbol includes the DL BWP. Subbands #1 to #6 are different CSI reporting subbands.

In some embodiments, the network device transmits CSI-RS to the terminal device. The network device does not transmit CSI-RS in the UL subband position, but transmits CSI-RS in the DL subband 1, DL subband 2, and DL BWP positions.

In some embodiments, the channel state information of the subband that needs to be reported is calculated based on the CSI-RS corresponding to the subband in the SBFD symbol and non-SBFD symbol.

Illustratively, for subband #1, in the SBFD symbol part, all the frequency-domain resources corresponding to subband #1 are located within DL subband 1, so channel state information of subband #1 can be reported. The channel state information of subband #1 can be calculated based on CSI-RS within (C, 12), (D, 12), (E, 12), (F, 12), (C, 11), (D, 11), (E, 11), and (F, 11), as well as CSI-RS within (G, 12), (H, 12), (I, 12), (G, 11), (H, 11), and (I, 11).

For subband #2, in the SBFD symbol part, the frequency-domain resource part corresponding to subband #2 is partially located within DL subband 1 and partially outside the DL subband 1. The channel state information of this type of subband can also be reported. The channel state information of subband #2 can be calculated based on CSI-RS within (C, 10), (D, 10), (E, 10), and (F, 10), as well as CSI-RS within (G, 10), (H, 10), (I, 10), (G, 9), (H, 9), and (I, 9).

For subband #3, in the SBFD symbol part, the frequency-domain resource part corresponding to subband #3 is entirely outside the downlink subband, so the channel state information of subband #3 can be calculated based on CSI-RS within (G, 8), (H, 8), (I, 8), (G, 7), (H, 7), and (I, 7).

The calculation method for channel state information of subband #4 to subband #6 is similar, and is not repeated herein.

In some embodiments, after calculating the aforementioned channel state information, the terminal device receives a first configuration transmitted by the network device. The first configuration is used by the terminal device to determine the subbands for which channel state information needs to be reported in the channel state information report. The terminal device transmits the aforementioned channel state information to the network device by reporting the channel state information report.

FIG. 4 illustrates a flowchart of a method for reporting a channel state information report according to some embodiments of the present disclosure. The method is performed by a terminal device and includes the following steps.

Step 410: Receiving a first configuration from a network device, wherein the first configuration is used for the terminal device to determine a subband for which channel state information needs to be reported in the channel state information report.

Channel state information includes at least one of: CQI, PMI, rank indicator (RI), Reference Signal Received Quality (RSRQ), Reference Signal Received Power (RSRP), or the like.

In some embodiments, the channel state information report includes bits corresponding to a first subband, wherein the first subband is a subband whose entire frequency domain bandwidth is outside the downlink subband, or the first subband is a subband whose entire frequency domain bandwidth overlaps with the uplink subband and/or guard band.

By way of example and not limitation, the bitmap of the CSI reporting subband parameter (csi-ReportingBand) in the first configuration includes multiple bits, and the number of these multiple bits is the same as the number of CSI reporting subbands.

Illustratively, in FIG. 3, there are a total of 6 subbands, namely subband #1 to subband #6. Therefore, the bitmap for CSI reporting subband parameters consists of 6 bits, which correspond to subband #1 to subband #6 respectively. Subband #3 is the first subband, and the entire frequency domain bandwidth of subband #3 is outside the downlink subbands.

In some embodiments, the channel state information report is associated with a first type of time-domain resource and/or a second type of time-domain resource.

Time-domain resources include at least one of: symbol, symbol group, slot, sub-slot, frame, or subframe. In embodiments of the present disclosure, the specific type of time-domain resources is not limited. By way of example and not limitation, the first type of time-domain resource is a time-domain resource of the SBFD type, such as an SBFD symbol, and the second type of time-domain resource is a time-domain resource of the non-SBFD type, such as a non-SBFD symbol. The SBFD symbol is a symbol that includes at least one of an uplink subband, a downlink subband, or a guard band, and a non-SBFD symbol is a symbol that does not include any of the above subbands.

Step 420: Reporting the channel state information report.

In some embodiments, the channel state information report does not include the channel state information corresponding to the first subband, or the channel state information report may include the channel state information corresponding to other subbands excluding the first subband.

By way of example and not limitation, channel state information reports are reported through the PUCCH.

After obtaining the channel state information report, the terminal device transmits the channel state information report to the network device for the network device to assess the channel transmission quality.

In some embodiments, the channel state information report or the configuration manner associated with the first configuration includes at least one of the following:

Manner 1: The bit corresponding to the first subband in the channel state information report is assigned a specified value.

By way of example and not limitation, in the case where the network device has not configured the first higher-layer parameter for the terminal device, the specified value is the first value; in the case where the network device has configured the first higher-layer parameter for the terminal device, the specified value is the second value; wherein the first higher-layer parameter is used to indicate the number of bits corresponding to each subband in the channel state information report.

Illustratively, the first higher-layer parameter is cqi-BitsPerSubband, which specifies the number of bits of CQI for each subband. In the absence of the first higher-layer parameter, the specified value is 3 (i.e., binary 11); in the presence of the first higher-layer parameter, the specified value is 0 (i.e., binary 0000), indicating out of range, which may indicate measurement issues, representing poor channel quality for the first subband.

By setting the bits corresponding to the first subband to a specified value to indicate that the channel quality of the first subband is poor, it can be explained that the first subband is a subband where all frequency domain bandwidths are outside the downlink subband, while being compatible with the existing format of channel state information reports.

Manner 2: The value of the bit corresponding to the first subband in the channel state information report is autonomously implemented by the terminal device.

Illustratively, the terminal device sets the value of the bit corresponding to the first subband to 0, 1, or other values.

Since the network device does not care about the channel quality on the first subband outside the downlink subband, how the terminal device sets the value of the bit corresponding to the first subband does not have any impact. Therefore, it can be implemented autonomously by the terminal device, which is more flexible and free, while being compatible with the existing format of channel state information report.

In some embodiments, when SBFD symbols and non-SBFD symbols share the same CSI report configuration (CSI-ReportConfig), the measurement resources corresponding to each channel state information report occupy SBFD symbols and/or non-SBFD symbols.

As shown in FIG. 3, since SBFD symbols and non-SBFD symbols share the same CSI reporting configuration, there may be a situation where some channel state information reports are associated with the measurement resources of SBFD symbols, while other channel state information reports are associated with the measurement resources of non-SBFD symbols.

For SBFD symbols, the network device knows that the uplink subband and guard band cannot be used for downlink scheduling, so the network device only expects to obtain the channel state information of the CSI reporting subbands that overlap with the downlink subbands, such as the channel state information of subbands #1, #2, #4, #5, and #6. For non-SBFD symbols, since the entire bandwidth can be used for downlink scheduling, the network device expects to obtain the channel state information of each CSI reporting subband. Assuming that the bitmap of the CSI reporting subband parameter (csi-ReportingBand) in the CSI reporting configuration is configured as 111111, and each CSI reporting subband corresponds to a 2-bit differential CSI reporting result, then the differential CSI reporting results for subbands #1, #2, #4, #5, and #6 are calculated based on the CSI-RS within their corresponding downlink subbands.

For subband #3, since there is no CSI-RS within a corresponding downlink subband, for the 2-bit differential CSI reporting result corresponding to subband #3, the terminal device may set the value of the bit corresponding to subband #3 to 3 according to manner 1; alternatively, the terminal device may set the aforementioned 2 bits based on autonomous implementation according to manner 2, such as setting them to 0, 1, or other values.

Manner 1 and manner 2 can ensure that all channel state information reports (regardless of whether they are associated with SBFD symbols or non-SBFD symbols) have the same payload size. That is, for each CSI report configuration, the terminal device only needs to maintain one payload size. For example, in the above embodiment, each channel state information report reports 2*6=12 bits, thus maintaining the same physical uplink control channel (PUCCH) resource and simplifying the implementation of the terminal device.

Manner 3: The terminal device does not expect the first subband to be configured in the first configuration as the subband for which channel state information needs to be reported.

The first subband is a subband whose entire frequency domain bandwidth is outside the downlink subband, or the first subband is a subband whose entire frequency domain bandwidth overlaps with the uplink subband and/or the guard band.

By way of example and not limitation, the terminal device does not expect the bitmap of the CSI reporting subband parameter (csi-ReportingBand) in the first configuration to set the value of the bit corresponding to the first subband to 0 or 1.

Under the configuration limitations of the network device, the terminal device is prevented from reporting channel state information for the first subband, which more accurately indicates the subbands that do not require reporting of channel state information, while also saving overhead on the uplink control channel.

Manner 4: The channel state information report does not include the bits corresponding to the first subband.

The first subband is a subband whose entire frequency domain bandwidth is outside the downlink subband, or the first subband is a subband whose entire frequency domain bandwidth overlaps with the uplink subband and/or the guard band.

In some embodiments, the terminal device does not report the channel state information of the first subband; or the channel state information report reported by the terminal device skips the bits corresponding to the first subband; or the channel state information report reported by the terminal device drops the channel state information of the first subband.

Without increasing the configuration constraints of the network device, the terminal device may refrain from reporting the channel state information of the first subband by ignoring the indication of the network device for the first subband, making the implementation simpler.

In some embodiments, in the case where SBFD symbols and non-SBFD symbols correspond to different CSI report configurations (CSI-ReportConfig), the channel state information report associated with the SBFD symbols is calculated based on the CSI-RS in the SBFD symbols, and the channel state information report associated with the non-SBFD symbols is calculated based on the CSI-RS in the non-SBFD symbols.

As shown in FIG. 3, for SBFD symbols, the network device knows that the uplink subband and guard band cannot be used for downlink scheduling, so the network device only expects to obtain the channel state information of the CSI reporting subbands that overlap with the downlink subbands, such as the channel state information of subband #1, subband #2, subband #4, subband #5, and subband #6. For non-SBFD symbols, since the entire bandwidth can be used for downlink scheduling, the network device expects to obtain the channel state information of each CSI reporting subband.

According to manner 3, the terminal device does not expect the first subband to be configured in the first configuration as the subband for which channel state information needs to be reported. Subband #3 is the first subband, that is, the bitmap of the CSI reporting subband parameter in the first configuration may be configured as 110111. The corresponding bit value for subband #3 is 0.

According to manner 4, in the first configuration associated with the SBFD symbol, the bitmap for CSI reporting subband parameters may be configured as 111111. However, the terminal device does not include the bits corresponding to subband #3 in the reported channel state information report. That is, the terminal device only reports 2*5=10 bits, which correspond to subbands #1, subband #2, subband #4, subband #5, and subband #6, respectively.

In manner 3 and manner 4, for channel state information reports associated with SBFD symbols, the terminal device may only report channel state information for subbands other than the first subband, thereby saving bits for channel state information reports, reducing the load on the PUCCH, and improving transmission reliability.

Manner 5: The first configuration includes a first sub-configuration and a second sub-configuration. The first sub-configuration is associated with a first type of time-domain resource, and the second sub-configuration is associated with a second type of time-domain resource.

In some embodiments, the channel state information report includes at least one of a first channel state information report or a second channel state information report. The first channel state information report is associated with a first type of time-domain resource, and the second channel state information report is associated with a second type of time-domain resource. The first sub-configuration is used for the terminal device to determine the subband for which channel state information needs to be reported in the first channel state information report. The second sub-configuration is used for the terminal device to determine the subband for which channel state information needs to be reported in the second channel state information report.

By way of example and not limitation, the first configuration includes a first sub-configuration (csi-reportingbandSBFD) and a second sub-configuration (csi-reportingbandNONSBFD). For instance, in the first sub-configuration, only the channel state information of subbands overlapping with the downlink subbands is indicated for reporting, while in the second sub-configuration, the channel state information of all subbands is indicated for reporting. Another example is that in the first sub-configuration, the channel state information of some of the subbands that overlap with the downlink subbands is indicated for reporting, while in the second sub-configuration, the channel state information of some subbands is indicated for reporting.

In some embodiments, the method further includes: receiving a reference signal from a network device.

Illustratively, the reference signal includes a CSI-RS or other downlink channel reference signal.

In some embodiments, the first channel state information report is calculated based on reference signals in a first type of time-domain resource; the second channel state information report is calculated based on reference signals in a second type of time-domain resource.

Illustratively, as shown in FIG. 3, for subband #1, the channel state information report (the first channel state information report) associated with the SBFD symbol is calculated based on the reference signals in the SBFD symbol, for example, it can be calculated based on the CSI-RS within (C, 12), (D, 12), (E, 12), (F, 12), (C, 11), (D, 11), (E, 11), and (F, 11). The channel state information report (the second channel state information report) associated with the non-SBFD symbol is calculated based on the reference signals in the non-SBFD symbol, for example, it can be calculated based on the CSI-RS within (G, 12), (H, 12), (I, 12), (G, 11), (H, 11), and (I, 11).

In some embodiments, the first channel state information report includes a bit corresponding to a first subband.

In some embodiments, the bit corresponding to the first subband in the first channel state information report is assigned a specified value.

By way of example and not limitation, in the case where the network device has not configured the first higher-layer parameter for the terminal device, the specified value is the first value; in the case where the network device has configured the first higher-layer parameter for the terminal device, the specified value is the second value. The first higher-layer parameter is used to indicate the number of bits corresponding to each subband in the channel state information report.

For specific implementation details, reference may be made to manner 1, which are not elaborated upon herein.

In some embodiments, the value of the bit corresponding to the first subband in the first channel state information report is autonomously implemented by the terminal device.

For specific implementation details, reference may be made to manner 2, which are not elaborated upon herein.

In some embodiments, the terminal device does not expect the first subband to be configured in the first sub-configuration as a subband for which channel state information needs to be reported. The first subband is a subband whose entire frequency domain bandwidth is outside the downlink subband, or the first subband is a subband whose entire frequency domain bandwidth overlaps with the uplink subband and/or guard band.

For specific implementation details, reference may be made to manner 3, which are not elaborated upon herein.

In some embodiments, the first channel state information report does not include bits corresponding to the first subband; wherein the first subband is a subband whose entire frequency domain bandwidth is outside the downlink subband, or the first subband is a subband whose entire frequency domain bandwidth overlaps with the uplink subband and/or guard band.

For specific implementation details, reference may be made to manner 4, which are not elaborated upon herein.

Manner 5 uses two sub-configurations to indicate separately, reporting channel state information for different subbands for the first type of time-domain resource and the second type of time-domain resource, respectively, without increasing the complexity of processing by the terminal device.

In the aforementioned manners, each manner can be implemented individually or in combination. For example, manner 5 may be implemented in combination with manner 1 and/or manner 2, and manner 5 may also be implemented in combination with manner 3 and/or manner 4. Embodiments of the present disclosure do not impose any limitations on this, and each manner is described as being implemented individually.

In summary, in the method according to the embodiments, channel state information report is reported after receiving the first configuration from the network device. The first configuration is used for the terminal device to determine the subbands for which channel state information needs to be reported in the channel state information report. This method enables reporting of the channel state information of the subbands for which channel state information needs to be reported in the channel state information report, while the channel state information of other subbands is not reported, such as the channel state information of subbands located within the uplink subband, thereby more accurately reporting the channel state information required by the network device.

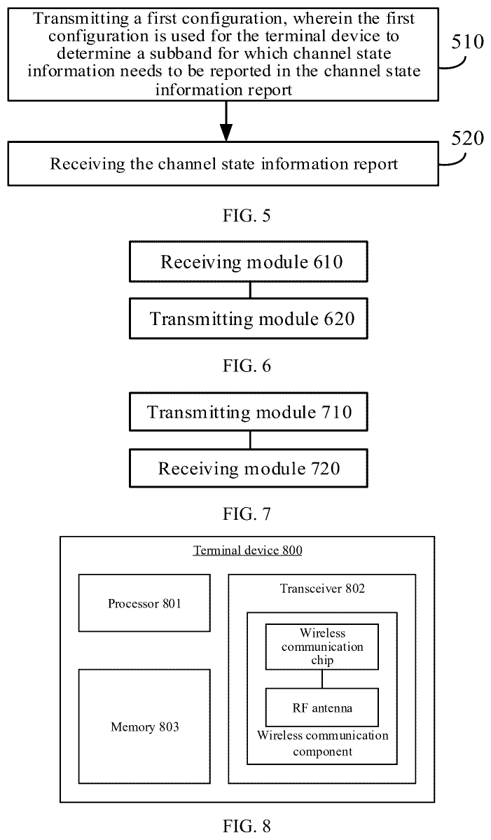

FIG. 5 illustrates a flowchart of a method for receiving a channel state information report according to some embodiments of the present disclosure. The method is performed by a network device and includes the following steps.

Step 510: Transmitting a first configuration, wherein the first configuration is used for the terminal device to determine a subband for which channel state information needs to be reported in the channel state information report.

Channel state information includes at least one of: CQI, PMI, RI, RSRQ, RSRP, or the like.

In some embodiments, the channel state information report includes bits corresponding to a first subband, wherein the first subband is a subband whose entire frequency domain bandwidth is outside the downlink subband, or the first subband is a subband whose entire frequency domain bandwidth overlaps with the uplink subband and/or the guard band.

By way of example and not limitation, the bitmap of the CSI reporting subband parameter (csi-ReportingBand) in the first configuration includes multiple bits, and the number of these bits is the same as the number of CSI reporting subbands.

Illustratively, in FIG. 3, there are a total of 6 subbands, namely subband #1 to subband #6. Therefore, the bitmap for CSI reporting subband parameters consists of 6 bits, which correspond to subband #1 to subband #6 respectively. Subband #3 is the first subband, and the entire frequency domain bandwidth of subband #3 is outside the downlink subbands.

In some embodiments, the channel state information report is associated with a first type of time-domain resource and/or a second type of time-domain resource.

Time-domain resources include at least one of symbols, symbol groups, slots, sub-slots, frames, or subframes. In embodiments of the present disclosure, the specific type of time-domain resources is not limited. By way of example and not limitation, the first type of time-domain resource is a time-domain resource of the SBFD type, such as an SBFD symbol, and the second type of time-domain resource is a time-domain resource of the non-SBFD type, such as a non-SBFD symbol. The SBFD symbol is a symbol that includes at least one of an uplink subband, a downlink subband, or a guard band, while the non-SBFD symbol is a symbol that does not include any of the above subbands.

Step 520: Receiving the channel state information report.

In some embodiments, the channel state information report does not include the channel state information corresponding to the first subband, or the channel state information report may include the channel state information corresponding to other subbands other than the first subband.

After receiving the channel state information from the terminal device, the network device judges the channel transmission quality based on the channel state information.

In some embodiments, the channel state information report or the configuration manner associated with the first configuration includes at least one of the following:

Manner 1: The bit corresponding to the first subband in the channel state information report is assigned a specified value.

By way of example and not limitation, in the case where the network device has not configured the first higher-layer parameter for the terminal device, the specified value is the first value; in the case where the network device has configured the first higher-layer parameter for the terminal device, the specified value is the second value; wherein the first higher-layer parameter is used to indicate the number of bits corresponding to each subband in the channel state information report.

Illustratively, the first higher-layer parameter is cqi-BitsPerSubband, which specifies the number of bits of CQI for each subband. In the absence of the first higher-layer parameter, the specified value is 3 (i.e., 11 in binary); in the presence of the first higher-layer parameter, the specified value is 0 (i.e., 0000 in binary), indicating out of range, which may indicate measurement issues and represents poor channel quality for the first subband.

By setting the bits corresponding to the first subband to a specified value to indicate poor channel quality of the first subband, it can be explained that the first subband is a subband where all frequency domain bandwidths are outside the downlink subband, while being compatible with the existing format of channel state information report.

Manner 2: The value of the bit corresponding to the first subband in the channel state information report is autonomously implemented by the terminal device.

Illustratively, the terminal device sets the value of the bit corresponding to the first subband to 0, 1, or another value.

Since the network device does not care about the channel quality on the first subband outside the downlink subbands, how the terminal device sets the value of the bit corresponding to the first subband does not have any impact. Therefore, it can be implemented autonomously by the terminal device, which is more flexible and free, while being compatible with the existing format of channel state information reports.

In some embodiments, when SBFD symbols and non-SBFD symbols share the same CSI report configuration (CSI-ReportConfig), the measurement resources corresponding to each channel state information report occupy SBFD symbols and/or non-SBFD symbols.

As shown in FIG. 3, since SBFD symbols and non-SBFD symbols share the same CSI reporting configuration, there may be a situation where some channel state information reports are associated with the measurement resources of SBFD symbols, while other channel state information reports are associated with the measurement resources of non-SBFD symbols.

For SBFD symbols, the network device knows that the uplink subband and guard band cannot be used for downlink scheduling, so the network device only expects to obtain the CSI of the CSI reporting subbands that overlap with the downlink subbands, such as the CSI of subband #1, subband #2, subband #4, subband #5, and subband #6. For non-SBFD symbols, since the entire bandwidth can be used for downlink scheduling, the network device expects to obtain the CSI of each CSI reporting subband. Assuming that the bitmap of the CSI reporting subband parameter (csi-ReportingBand) in the CSI reporting configuration is configured as 111111, and each CSI reporting subband corresponds to a 2-bit differential CSI reporting result, then the differential CSI reporting results for subband #1, subband #2, subband #4, subband #5, and subband #6 are calculated based on the CSI-RS within their corresponding downlink subbands.

For subband #3, since there is no CSI-RS within the corresponding downlink subband, for the 2-bit differential CSI reporting result corresponding to subband #3, the terminal device may set the value of the bit corresponding to subband #3 to 3 according to manner 1; alternatively, the terminal device may set the aforementioned 2 bits based on autonomous implementation according to manner 2, such as setting them to 0, 1, or other values.

Manner 1 and manner 2 can ensure that all channel state information reports (regardless of whether they are associated with SBFD symbols or non-SBFD symbols) have the same payload size. That is, for each CSI report configuration, the terminal device only needs to maintain one payload size. For example, in the above embodiment, each channel state information report reports 2*6=12 bits, thus maintaining the same PUCCH resource and simplifying the implementation of the terminal device.

Manner 3: In the first configuration, the first subband is configured as a subband for which channel state information does not need to be reported.

The first subband is a subband whose entire frequency domain bandwidth is outside the downlink subband, or the first subband is a subband whose entire frequency domain bandwidth overlaps with the uplink subband and/or the guard band.

By way of example and not limitation, in the first configuration, the bitmap of the CSI reporting subband parameter (csi-ReportingBand) sets the value of the bit corresponding to the first subband to 3 or another value, indicating that the first subband is a subband for which channel state information does not need to be reported.

Under limitations imposed by the configuration of the network device, the terminal device is prevented from reporting channel state information for the first subband, which more accurately indicate the subbands that do not require reporting of channel state information, while also saving overhead on the uplink control channel.

Manner 4: The channel state information report does not include the bits corresponding to the first subband.

The first subband is a subband whose entire frequency domain bandwidth is outside the downlink subband, or the first subband is a subband whose entire frequency domain bandwidth overlaps with the uplink subband and/or the guard band.

In some embodiments, the terminal device does not report the channel state information of the first subband; or the channel state information report reported by the terminal device skips the bits corresponding to the first subband; or the channel state information report reported by the terminal device drops the channel state information of the first subband.

Without increasing the configuration constraints of the network device, the terminal device does not report the channel state information of the first subband by ignoring the indication of the network device for the first subband, making the implementation simpler.

In some embodiments, in the case where SBFD symbols and non-SBFD symbols correspond to different CSI report configurations (CSI-ReportConfig), the channel state information report associated with the SBFD symbol is calculated based on the CSI-RS in the SBFD symbol, and the channel state information report associated with the non-SBFD symbol is calculated based on the CSI-RS in the non-SBFD symbol.

As shown in FIG. 3, for SBFD symbols, the network device knows that the uplink subband and guard band cannot be used for downlink scheduling, so the network device only expects to obtain the channel state information of the CSI reporting subbands that overlap with the downlink subbands, such as the channel state information of subband #1, subband #2, subband #4, subband #5, and subband #6. For non-SBFD symbols, since the entire bandwidth can be used for downlink scheduling, the network device expects to obtain the channel state information of each CSI reporting subband.

According to manner 3, the terminal device does not expect the first subband to be configured in the first configuration as the subband for which channel state information needs to be reported. Subband #3 is the first subband, that is, the bitmap of the CSI reporting subband parameter in the first configuration may be configured as 110111. The corresponding bit value for subband #3 is 0.

According to manner 4, in the first configuration associated with SBFD symbols, the network device may configure the bitmap for CSI reporting subband parameters as 111111. However, the terminal device does not include the bits corresponding to subband #3 in the reported channel state information. Specifically, the terminal device only reports 2*5=10 bits, which correspond to subband #1, subband #2, subband #4, subband #5, and subband #6, respectively.

In manner 3 and manner 4, for channel state information reports associated with SBFD symbols, the terminal device may only report channel state information for subbands other than the first subband, thereby saving bits for channel state information reports, reducing the load on the PUCCH, and improving transmission reliability.

Manner 5: The first configuration includes a first sub-configuration and a second sub-configuration. The first sub-configuration is associated with a first type of time-domain resource, and the second sub-configuration is associated with a second type of time-domain resource.

In some embodiments, the channel state information report includes at least one of a first channel state information report or a second channel state information report. The first channel state information report is associated with a first type of time-domain resource, and the second channel state information report is associated with a second type of time-domain resource. The first sub-configuration is used for the terminal device to determine the subband for which channel state information needs to be reported in the first channel state information report. The second sub-configuration is used for the terminal device to determine the subband for which channel state information needs to be reported in the second channel state information report.

By way of example and not limitation, the first configuration includes a first sub-configuration (csi-reportingbandSBFD) and a second sub-configuration (csi-reportingbandNONSBFD). For instance, in the first sub-configuration, only the channel state information of subbands that overlap with the downlink subbands is indicated for reporting. In the second sub-configuration, the channel state information of all subbands is indicated for reporting. As another example, in the first sub-configuration, the channel state information of some of the subbands that overlap with the downlink subbands is indicated for reporting. In the second sub-configuration, the channel state information of some subbands is indicated for reporting.

In some embodiments, the first channel state information report is calculated based on reference signals in a first type of time-domain resource; the second channel state information report is calculated based on reference signals in a second type of time-domain resource.

Illustratively, as shown in FIG. 3, for subband #1, the channel state information report (the first channel state information report) associated with the SBFD symbol is calculated based on the reference signals in the SBFD symbol, for example, it can be calculated based on the CSI-RS within (C, 12), (D, 12), (E, 12), (F, 12), (C, 11), (D, 11), (E, 11), and (F, 11). The channel state information report (the second channel state information report) associated with the non-SBFD symbol is calculated based on the reference signals in the non-SBFD symbol, for example, it can be calculated based on the CSI-RS within (G, 12), (H, 12), (I, 12), (G, 11), (H, 11), and (I, 11).

In some embodiments, the first channel state information report includes bits corresponding to a first subband.

In some embodiments, the bit corresponding to the first subband in the first channel state information report is assigned a specified value.

By way of example and not limitation, in the case where the network device has not configured the first higher-layer parameter for the terminal device, the specified value is the first value; in the case where the network device has configured the first higher-layer parameter for the terminal device, the specified value is the second value. The first higher-layer parameter is used to indicate the number of bits corresponding to each subband in the channel state information report.

For specific implementation details, reference may be made to manner 1, which are not elaborated upon herein.

In some embodiments, the value of the bit corresponding to the first subband in the first channel state information report is autonomously implemented by the terminal device.

For specific implementation details, reference may be made to manner 2, which are not elaborated upon herein.

In some embodiments, in the first sub-configuration, the first subband is configured as a subband for which channel state information does not need to be reported. The first subband is a subband whose entire frequency domain bandwidth is outside the downlink subband, or the first subband is a subband whose entire frequency domain bandwidth overlaps with the uplink subband and/or guard band.

For specific implementation details, reference may be made to manner 3, which are not elaborated upon herein.

In some embodiments, the first channel state information report does not include bits corresponding to the first subband; wherein the first subband is a subband whose entire frequency domain bandwidth is outside the downlink subband, or the first subband is a subband whose entire frequency domain bandwidth overlaps with the uplink subband and/or guard band.

For specific implementation details, reference may be made to manner 4, which are not elaborated upon herein.

Method five indicates separately through two sub-configurations, reporting channel state information for different subbands for the first type of time-domain resource and the second type of time-domain resource, respectively, without increasing the complexity of processing by the terminal device.

In the above manners, each manner can be implemented individually or in combination. For example, manner 5 may be implemented in combination with manner 1 and/or manner 2, and manner 5 may also be implemented in combination with manner 3 and/or manner 4. Embodiments of the present disclosure do not impose any limitations on this, and each manner is described as being implemented individually.

In summary, in the method according to the embodiments, after transmitting the first configuration, channel state information report is received from the terminal device. The first configuration is used for the terminal device to determine the subbands for which channel state information needs to be reported in the channel state information report. Through this method, the channel state information of the subband for which channel state information needs to be reported can be obtained through the channel state information report, while the channel state information of other subbands is not obtained, such as the channel state information of subbands located within the uplink subband, thereby more accurately obtaining the required channel state information.

In the above embodiments, the embodiments corresponding to FIG. 4 and the embodiments corresponding to FIG. 5 may be implemented separately or in combination, and the present disclosure does not limit this.

The following description corresponds to manner 1 and manner 2.

In some embodiments, when SBFD symbols and non-SBFD symbols share the same CSI report configuration (CSI-ReportConfig), the measurement resources corresponding to each channel state information report occupy SBFD symbols and/or non-SBFD symbols.

As shown in FIG. 3, since SBFD symbols and non-SBFD symbols share the same CSI reporting configuration, there may be a situation where some channel state information reports are associated with the measurement resources of SBFD symbols, while other channel state information reports are associated with the measurement resources of non-SBFD symbols.

For SBFD symbols, the network device knows that the uplink subband and guard band cannot be used for downlink scheduling, so the network device only expects to obtain the CSI of the CSI reporting subbands that overlap with the downlink subbands, such as the channel state information of subbands #1, #2, #4, #5, and #6. For non-SBFD symbols, since the entire bandwidth can be used for downlink scheduling, the network device expects to obtain the channel state information of each CSI reporting subband. Assuming that the bitmap of the CSI reporting subband parameter (csi-ReportingBand) in the CSI reporting configuration is configured as 111111, and each CSI reporting subband corresponds to a 2-bit differential CSI reporting result, then the differential CSI reporting results for subbands #1, #2, #4, #5, and #6 are calculated based on the CSI-RS within their corresponding downlink subbands.

For subband #3, since there is no CSI-RS within the corresponding downlink subband, for the 2-bit differential CSI reporting result corresponding to subband #3, the terminal device may set the value of the bit corresponding to subband #3 to 3 according to manner 1; alternatively, the terminal device may set the aforementioned 2 bits based on autonomous implementation according to manner 2, such as setting them to 0, 1, or other values.

Manner 1 and manner 2 can ensure that all channel state information reports (regardless of whether they are associated with SBFD symbols or non-SBFD symbols) have the same payload size. That is, for each CSI report configuration, the terminal device only needs to maintain one payload size. For example, in the above embodiment, each channel state information report reports 2*6=12 bits, thus maintaining the same PUCCH resource and simplifying the implementation of the terminal device.

The following description corresponds to manner 3 and manner 4.

In some embodiments, in the case where SBFD symbols and non-SBFD symbols correspond to different CSI report configurations (CSI-ReportConfig), the channel state information report associated with the SBFD symbols is calculated based on the CSI-RS in the SBFD symbols, and the channel state information report associated with the non-SBFD symbols is calculated based on the CSI-RS in the non-SBFD symbols.

As shown in FIG. 3, for SBFD symbols, the network device knows that the uplink subband and guard band cannot be used for downlink scheduling, so the network device only expects to obtain the channel state information of the CSI reporting subbands that overlap with the downlink subbands, such as the channel state information of subband #1, subband #2, subband #4, subband #5, and subband #6. For non-SBFD symbols, since the entire bandwidth can be used for downlink scheduling, the network device expects to obtain the channel state information of each CSI reporting subband.

According to manner 3, the terminal device does not expect the first subband to be configured in the first configuration as the subband for which channel state information needs to be reported. Subband #3 is the first subband, that is, the bitmap of the CSI reporting subband parameter in the first configuration may be configured as 110111. The corresponding bit value for subband #3 is 0.

According to manner 4, in the first configuration associated with SBFD symbols, the bitmap for CSI reporting subband parameters may be configured as 111111. However, the terminal device does not include the bits corresponding to subband #3 in the reported channel state information report. That is, the terminal device only reports 2*5=10 bits, which correspond to subbands #1, subband #2, subband #4, subband #5, and subband #6, respectively.

In manner 3 and manner 4, for channel state information reports associated with SBFD symbols, the terminal device may only report channel state information for subbands other than the first subband, thereby saving bits for channel state information reports, reducing the load on the PUCCH, and improving transmission reliability.

The following description corresponds to manner 5.

In some embodiments, when SBFD symbols and non-SBFD symbols share the same CSI report configuration (CSI-ReportConfig), the measurement resources corresponding to each channel state information report occupy SBFD symbols and/or non-SBFD symbols.

The first configuration includes a first sub-configuration (csi-reportingbandSBFD) and a second sub-configuration (csi-reportingbandNONSBFD). For instance, in the first sub-configuration, only the channel state information of subbands overlapping with the downlink subbands is indicated for reporting. In the second sub-configuration, the channel state information of all subbands is indicated for reporting. As another example, in the first sub-configuration, the channel state information of some of the subbands that overlap with the downlink subbands is indicated for reporting. In the second sub-configuration, the channel state information of some subbands is indicated for reporting.

The first sub-configuration is used to configure the subband for which channel state information is reported in the CSI report (first CSI report) associated with SBFD symbols, and the second sub-configuration is used to configure the subbands for which channel state information is reported in the CSI report (second CSI report) associated with non-SBFD symbols.

In some embodiments, the channel state information report includes at least one of a first channel state information report or a second channel state information report. The first channel state information report is associated with a first type of time-domain resource, and the second channel state information report is associated with a second type of time-domain resource. The first channel state information report is calculated based on a reference signal in the first type of time-domain resource; and the second channel state information report is calculated based on a reference signal in the second type of time-domain resource.

Illustratively, as shown in FIG. 3, for subband #1, the channel state information report associated with SBFD symbols is calculated based on the reference signals in the SBFD symbols, for example, it can be calculated based on the CSI-RS within (C, 12), (D, 12), (E, 12), (F, 12), (C, 11), (D, 11), (E, 11), and (F, 11). The channel state information report associated with non-SBFD symbols is calculated based on the reference signals in the non-SBFD symbols, for example, it can be calculated based on the CSI-RS within (G, 12), (H, 12), (I, 12), (G, 11), (H, 11), and (I, 11).

FIG. 6 illustrates a block diagram of an apparatus for reporting a channel state information report according to some embodiments of the present disclosure. The apparatus can be implemented as a terminal device or as a part of a terminal device through software, hardware, or a combination of both. The apparatus includes a receiving module 610 and a transmitting module 620.

The receiving module 610 is configured to receive a first configuration from a network device, wherein the first configuration is used for the apparatus for reporting the channel state information report to determine a subband for which channel state information needs to be reported in the channel state information report.

The transmitting module 620 is used for reporting the channel state information report.

Channel state information includes at least one of: CQI, PMI, RI, RSRQ, RSRP, or the like.

In one possible design of the embodiments, the channel state information report includes bits corresponding to a first subband, wherein the first subband is a subband whose entire frequency domain bandwidth is outside the downlink subband, or the first subband is a subband whose entire frequency domain bandwidth overlaps with the uplink subband and/or guard band.

By way of example and not limitation, the bitmap of the CSI reporting subband parameter (csi-ReportingBand) in the first configuration includes multiple bits, and the number of these multiple bits is the same as the number of CSI reporting subbands.

Illustratively, in FIG. 3, there are a total of 6 subbands, namely subband #1 to subband #6. Therefore, the bitmap for CSI reporting subband parameters consists of 6 bits, corresponding to subband #1 to subband #6 respectively. Subband #3 is the first subband, and the entire frequency domain bandwidth of subband #3 is outside the downlink subbands.

In one possible design of the embodiments, the channel state information report is associated with a first type of time-domain resource and/or a second type of time-domain resource.

Time-domain resources include at least one of: symbol, symbol group, slot, sub-slot, frame, or subframe. In embodiments of the present disclosure, the specific type of time-domain resources is not limited. By way of example and not limitation, the first type of time-domain resource is a time-domain resource of the SBFD type, such as an SBFD symbol, and the second type of time-domain resource is a time-domain resource of the non-SBFD type, such as a non-SBFD symbol. The SBFD symbol is a symbol that includes at least one of an uplink subband, a downlink subband, or a guard band, and a non-SBFD symbol is a symbol that does not include any of the above subbands.

In one possible design of the embodiments, the channel state information report does not include the channel state information corresponding to the first subband, or the channel state information report may include the channel state information corresponding to other subbands except for the first subband.

By way of example and not limitation, channel state information reports are reported through the PUCCH.

After obtaining the channel state information report, the apparatus for reporting the channel state information report transmits the channel state information report to the network device for the network device to judge the channel transmission quality.

In one possible design of the embodiments, the channel state information report or the configuration manner associated with the first configuration includes at least one of the following:

Manner 1: The bit corresponding to the first subband in the channel state information report is assigned a specified value.

By way of example and not limitation, in the case where the network device has not configured the first higher-layer parameter to the apparatus for reporting the channel state information report, the specified value is the first value; in the case where the network device has configured the first higher-layer parameter to the apparatus for reporting the channel state information report, the specified value is the second value; wherein the first higher-layer parameter is used to indicate the number of bits corresponding to each subband in the channel state information report.

Illustratively, the first higher-layer parameter is cqi-BitsPerSubband, which specifies the number of bits of CQI for each subband. In the absence of the first higher-layer parameter, the specified value is 3 (i.e., 11 in binary); in the presence of the first higher-layer parameter, the specified value is 0 (i.e., 0000 in binary), indicating out of range, which may indicate measurement issues and represents poor channel quality for the first subband.

By setting the bits corresponding to the first subband to a specified value to indicate poor channel quality of the first subband, it can be illustrated that the first subband is a subband where all frequency domain bandwidths are outside the downlink subband, while being compatible with the existing format of channel state information reports.

Manner 2: The value of the bit corresponding to the first subband in the channel state information report is autonomously implemented by the apparatus for reporting the channel state information report.

Illustratively, the apparatus for reporting the channel state information report sets the value of the bit corresponding to the first subband to 0, 1, or another value.

Since the network device does not care about the channel quality on the first subband outside the downlink subband, how the apparatus for reporting the channel state information report sets the value of the bit corresponding to the first subband does not have any impact. Therefore, it can be implemented autonomously based on the apparatus for reporting the channel state information report, which is more flexible and free, while being compatible with existing formats of channel state information reports.

In one possible design of the embodiments, when SBFD symbols and non-SBFD symbols share the same CSI report configuration (CSI-ReportConfig), the measurement resources corresponding to each channel state information report occupy SBFD symbols and/or non-SBFD symbols.

As shown in FIG. 3, since SBFD symbols and non-SBFD symbols share the same CSI reporting configuration, there may be a situation where some channel state information reports are associated with the measurement resources of SBFD symbols, while other channel state information reports are associated with the measurement resources of non-SBFD symbols.

For SBFD symbols, the network device knows that the uplink subband and guard band cannot be used for downlink scheduling, so the network device only expects to obtain the CSI of the CSI reporting subbands that overlap with the downlink subbands, such as the channel state information of subband #1, subband #2, subband #4, subband #5, and subband #6. For non-SBFD symbols, since the entire bandwidth can be used for downlink scheduling, the network device expects to obtain the channel state information of each CSI reporting subband. Assuming that the bitmap of the CSI reporting subband parameter (csi-ReportingBand) in the CSI reporting configuration is configured as 111111, and each CSI reporting subband corresponds to a 2-bit differential CSI reporting result, then the differential CSI reporting results for subband #1, subband #2, subband #4, subband #5, and subband #6 are calculated based on the CSI-RS within their corresponding downlink subbands.

For subband #3, since there is no CSI-RS within a corresponding downlink subband, for the 2-bit differential CSI reporting result corresponding to subband #3, the apparatus for reporting the channel state information report may set the value of the bit corresponding to subband #3 to 3 according to manner 1; alternatively, the apparatus for reporting the channel state information report may set the aforementioned 2 bits based on autonomous implementation according to manner 2, such as setting them to 0, 1, or other values.

Manner 1 and manner 2 can ensure that all channel state information reports (regardless of whether they are associated with SBFD symbols or non-SBFD symbols) have the same payload size. That is, the apparatus for reporting the channel state information report only needs to maintain one payload size for each CSI report configuration. For example, in the above embodiment, each channel state information report reports 2*6-12 bits, thus maintaining the same physical uplink control channel (PUCCH) resource and simplifying the implementation of the apparatus for reporting the channel state information report.

Manner 3: The apparatus for reporting the channel state information report does not expect the first subband to be configured in the first configuration as the subband for which channel state information needs to be reported.

The first subband is a subband whose entire frequency domain bandwidth is outside the downlink subband, or the first subband is a subband whose entire frequency domain bandwidth overlaps with the uplink subband and/or the guard band.

By way of example and not limitation, the apparatus for reporting the channel state information report does not expect the bitmap of the CSI reporting subband parameter (csi-ReportingBand) in the first configuration to set the value of the bit corresponding to the first subband to 0 or 1.

By configuration restrictions imposed by the network device, the apparatus for reporting the channel state information report is prevented from reporting channel state information for the first subband, which more accurately indicates the subbands that do not require reporting of channel state information, while also saving overhead on the uplink control channel.

Manner 4: The channel state information report does not include the bits corresponding to the first subband.

The first subband is a subband whose entire frequency domain bandwidth is outside the downlink subband, or the first subband is a subband whose entire frequency domain bandwidth overlaps with the uplink subband and/or the guard band.

In one possible design of the embodiments, the apparatus for reporting the channel state information report does not report the channel state information of the first subband; or the channel state information report reported by the apparatus for reporting the channel state information report skips the bits corresponding to the first subband; or the channel state information report reported by the apparatus for reporting the channel state information report drops the channel state information of the first subband.

Without increasing the configuration constraints of the network device, the apparatus for reporting the channel state information report ignores the indication of the network device for the first subband, thereby achieving the non-reporting of channel state information for the first subband, which is simpler to implement.

In one possible design of the embodiments, in the case where SBFD symbols and non-SBFD symbols correspond to different CSI report configurations (CSI-ReportConfig), the channel state information report associated with the SBFD symbol is calculated based on the CSI-RS in the SBFD symbol, and the channel state information report associated with the non-SBFD symbol is calculated based on the CSI-RS in the non-SBFD symbol.

As shown in FIG. 3, for SBFD symbols, the network device knows that the uplink subband and guard band cannot be used for downlink scheduling, so the network device only expects to obtain the channel state information of the CSI reporting subbands that overlap with the downlink subbands, such as the channel state information of subband #1, subband #2, subband #4, subband #5, and subband #6. For non-SBFD symbols, since the entire bandwidth can be used for downlink scheduling, the network device expects to obtain the channel state information of each CSI reporting subband.

According to manner 3, the apparatus for reporting the channel state information report does not expect the first subband to be configured in the first configuration as the subband for which channel state information needs to be reported. Subband #3 is the first subband, meaning the bitmap for the CSI reporting subband parameter in the first configuration may be configured as 110111. The corresponding bit value for subband #3 is 0.

According to manner 4, in the first configuration associated with the SBFD symbols, the bitmap for CSI reporting subband parameters may be configured as 111111. However, the apparatus for reporting the channel state information report does not include the bits corresponding to subband #3 in the reported channel state information report. That is, the apparatus for reporting the channel state information report only reports 2*5=10 bits, which correspond to subband #1, subband #2, subband #4, subband #5, and subband #6, respectively.

In manner 3 and manner 4, for channel state information reports associated with SBFD symbols, the apparatus for reporting the channel state information report may only report channel state information for subbands other than the first subband, thereby saving bits for channel state information reporting, reducing the load on the PUCCH, and improving transmission reliability.

Manner 5: The first configuration includes a first sub-configuration and a second sub-configuration. The first sub-configuration is associated with a first type of time-domain resource, and the second sub-configuration is associated with a second type of time-domain resource.

In one possible design of the embodiments, the channel state information report includes at least one of a first channel state information report or a second channel state information report. The first channel state information report is associated with a first type of time-domain resource, and the second channel state information report is associated with a second type of time-domain resource. The first sub-configuration is used for the apparatus for reporting the channel state information report to determine the subband for which channel state information needs to be reported in the first channel state information report. The second sub-configuration is used for the apparatus for reporting the channel state information report to determine the subband for which channel state information needs to be reported in the second channel state information report.

By way of example and not limitation, the first configuration includes a first sub-configuration (csi-reportingbandSBFD) and (csi-a second sub-configuration reportingbandNONSBFD). For instance, in the first sub-configuration, only the channel state information of subbands overlapping with the downlink subbands is indicated for reporting. In the second sub-configuration, the channel state information of all subbands is indicated for reporting. As another example, in the first sub-configuration, the channel state information of some of the subbands that overlap with the downlink subbands is indicated for reporting. In the second sub-configuration, the channel state information of some subbands is indicated for reporting.

In one possible design of the embodiments, the method further includes: receiving a reference signal from a network device.

Illustratively, the reference signal includes a CSI-RS or other downlink channel reference signal.

In one possible design of the embodiments, the first channel state information report is calculated based on the reference signal in the first type of time-domain resource; the second channel state information report is calculated based on the reference signal in the second type of time-domain resource.

Illustratively, as shown in FIG. 3, for subband #1, the channel state information report (first channel state information report) associated with the SBFD symbol is calculated based on the reference signals in the SBFD symbol, for example, it can be calculated based on the CSI-RS in (C, 12), (D, 12), (E, 12), (F, 12), (C, 11), (D, 11), (E, 11), and (F, 11). The channel state information report (second channel state information report) associated with the non-SBFD symbol is calculated based on the reference signals in the non-SBFD symbol, for example, it can be calculated based on the CSI-RS in (G, 12), (H, 12), (I, 12), (G, 11), (H, 11), and (I, 11).

In one possible design of the embodiments, the first channel state information report includes bits corresponding to the first subband.

In one possible design of the embodiments, the bit corresponding to the first subband in the first channel state information report is assigned a specified value.

By way of example and not limitation, in the case where the network device has not configured the first higher-layer parameter to the apparatus for reporting the channel state information report, the specified value is the first value; in the case where the network device has configured the first higher-layer parameter to the apparatus for reporting the channel state information report, the specified value is the second value. The first higher-layer parameter is used to indicate the number of bits corresponding to each subband in the channel state information report.

For specific implementation details, reference may be made to manner 1, which are not elaborated upon herein.

In one possible design of the embodiments, the value of the bit corresponding to the first subband in the first channel state information report is autonomously implemented by the apparatus for reporting the channel state information report.

For specific implementation details, reference may be made to manner 2, which are not elaborated upon herein.

In one possible design of the embodiments, the apparatus for reporting the channel state information report does not expect the first subband to be configured in the first sub-configuration as a subband for which channel state information needs to be reported. The first subband is a subband whose entire frequency domain bandwidth is outside the downlink subband, or the first subband is a subband whose entire frequency domain bandwidth overlaps with the uplink subband and/or guard band.

For specific implementation details, reference may be made to manner 3, which are not elaborated upon herein.

In one possible design of the embodiments, the first channel state information report does not include the bits corresponding to the first subband; wherein the first subband is a subband whose entire frequency domain bandwidth is outside the downlink subband, or the first subband is a subband whose entire frequency domain bandwidth overlaps with the uplink subband and/or guard band.

For specific implementation details, reference may be made to manner 4, which are not elaborated upon herein.

Manner 5 indicates separately through two sub-configurations, reporting channel state information for different subbands for both the first type of time-domain resource and the second type of time-domain resource, without increasing the complexity of the processing by the apparatus for reporting the channel state information report.

In the aforementioned manners, each manner can be implemented individually or in combination. For example, manner 5 may be implemented in combination with manner 1 and/or manner 2, and manner 5 may also be implemented in combination with manner 3 and/or Manner 4. The embodiments of the present disclosure do not impose any limitations on this, and each manner is described as being implemented individually.

The embodiments uses one receiving module 610 and one transmitting module 620 as examples for illustration, and the number of receiving modules 610 and transmitting modules 620 is not limited.

For the functional introduction of the receiving module 610, reference may be made to the content of step 410 in the embodiment shown in FIG. 4. For the functional introduction of the transmitting module 620, reference may be made to the content of step 420 in the embodiment shown in FIG. 4.

FIG. 7 illustrates a block diagram of an apparatus for receiving a channel state information report according to some embodiments of the present disclosure. The apparatus can be implemented as a network device or as a part of a network device through software, hardware, or a combination of both. The apparatus includes a transmitting module 710 and a receiving module 720.

The transmitting module 710 is configured to transmit a first configuration, wherein the first configuration is used for the terminal device to determine a subband for which channel state information needs to be reported in the channel state information report;

The receiving module 720 is configured to receive the channel state information report.

Channel state information includes at least one of: CQI, PMI, RI, RSRQ, RSRP, or the like.

In one possible design of the embodiments, the channel state information report includes bits corresponding to a first subband, wherein the first subband is a subband whose entire frequency domain bandwidth is outside the downlink subband, or the first subband is a subband whose entire frequency domain bandwidth overlaps with the uplink subband and/or guard band.

By way of example and not limitation, the bitmap of the CSI reporting subband parameter (csi-ReportingBand) in the first configuration includes multiple bits, and the number of these multiple bits is the same as the number of CSI reporting subbands.

Illustratively, in FIG. 3, there are a total of 6 subbands, namely subband #1 to subband #6. Therefore, the bitmap for CSI reporting subband parameters consists of 6 bits, which correspond to subband #1 to subband #6 respectively. Subband #3 is the first subband, and the entire frequency domain bandwidth of subband #3 is outside the downlink subbands.

In one possible design of the embodiments, the channel state information report is associated with a first type of time-domain resource and/or a second type of time-domain resource.

Time-domain resources include at least one of: symbol, symbol group, slot, sub-slot, frame, and subframe. In embodiments of the present disclosure, the specific type of time-domain resources is not limited. By way of example and not limitation, the first type of time-domain resource is a time-domain resource of the SBFD type, such as an SBFD symbol, and the second type of time-domain resource is a time-domain resource of the non-SBFD type, such as a non-SBFD symbol. The SBFD symbol is a symbol that includes at least one of an uplink subband, a downlink subband, or a guard band, while the non-SBFD symbol is a symbol that does not include any of the above subbands.

In one possible design of the embodiments, the channel state information report does not include the channel state information corresponding to the first subband, or the channel state information report may include the channel state information corresponding to other subbands other than the first subband.

After receiving the channel state information from the terminal device, the apparatus for receiving a channel state information report judges the channel transmission quality based on the channel state information.

In one possible design of the embodiments, the channel state information report or the configuration manner associated with the first configuration includes at least one of the following:

Manner 1: The bit corresponding to the first subband in the channel state information report is assigned a specified value.

By way of example and not limitation, in the case where the apparatus for receiving a channel state information report has not configured the first higher-layer parameter for the terminal device, the specified value is the first value; in the case where the apparatus for receiving a channel state information report has configured the first higher-layer parameter for the terminal device, the specified value is the second value; wherein the first higher-layer parameter is used to indicate the number of bits corresponding to each subband in the channel state information report.

Illustratively, the first higher-layer parameter is cqi-BitsPerSubband, which specifies the number of bits of CQI for each subband. In the absence of the first higher-layer parameter, the specified value is 3 (i.e., 11 in binary); in the presence of the first higher-layer parameter, the specified value is 0 (i.e., 0000 in binary), indicating out of range, which may indicate measurement issues, representing poor channel quality for the first subband.

By setting the bits corresponding to the first subband to a specified value to indicate poor channel quality of the first subband, it can be explained that the first subband is a subband where all frequency domain bandwidths are outside the downlink subband, while being compatible with the existing format of channel state information report.

Manner 2: The value of the bit corresponding to the first subband in the channel state information report is autonomously implemented by the terminal device.

Illustratively, the terminal device sets the value of the bit corresponding to the first subband to 0, 1, or other values.

Since the apparatus for receiving a channel state information report does not care about the channel quality on the first subband outside the downlink subbands, how the terminal device sets the value of the bit corresponding to the first subband does not have any impact. Therefore, it can be implemented autonomously by the terminal device, which is more flexible and free, while being compatible with the existing format of channel state information reports.

In one possible design of the embodiments, when SBFD symbols and non-SBFD symbols share the same CSI report configuration (CSI-ReportConfig), the measurement resources corresponding to each channel state information report occupy SBFD symbols and/or non-SBFD symbols.

As shown in FIG. 3, since SBFD symbols and non-SBFD symbols share the same CSI reporting configuration, there may be a situation where some channel state information reports are associated with the measurement resources of SBFD symbols, while other channel state information reports are associated with the measurement resources of non-SBFD symbols.

For SBFD symbols, the apparatus for receiving a channel state information reports knows that the uplink subbands and guard bands cannot be used for downlink scheduling, so the apparatus for receiving a channel state information report only expects to obtain the channel state information of the CSI reporting subbands that overlap with the downlink subbands, such as the channel state information for subbands #1, #2, #4, #5, and #6. For non-SBFD symbols, since the entire bandwidth can be used for downlink scheduling, the apparatus for receiving a channel state information report expects to obtain the channel state information for each CSI reporting subband. Assuming that the bitmap of the CSI reporting subband parameter (csi-ReportingBand) in the CSI reporting configuration is configured as 111111, and each CSI reporting subband corresponds to a 2-bit differential CSI reporting result, then the differential CSI reporting results for subbands #1, #2, #4, #5, and #6 are calculated based on the CSI-RS within their corresponding downlink subbands.

For subband #3, since there is no CSI-RS within a corresponding downlink subband, for the 2-bit differential CSI reporting result corresponding to subband #3, the terminal device may set the value of the bit corresponding to subband #3 to 3 according to manner 1; alternatively, the terminal device may set the aforementioned 2 bits based on autonomous implementation according to manner 2, such as setting them to 0, 1, or other values.

Manner 1 and manner 2 can ensure that all channel state information reports (regardless of whether they are associated with SBFD symbols or non-SBFD symbols) have the same payload size. That is, for each CSI report configuration, the terminal device only needs to maintain one payload size. For example, in the above embodiment, each channel state information report reports 2*6=12 bits, thus maintaining the same PUCCH resource and simplifying the implementation of the terminal device.

Manner 3: In the first configuration, the first subband is configured as a subband for which channel state information does not need to be reported.

The first subband is a subband whose entire frequency domain bandwidth is outside the downlink subband, or the first subband is a subband whose entire frequency domain bandwidth overlaps with the uplink subband and/or the guard band.

By way of example and not limitation, in the first configuration, the bitmap of the CSI reporting subband parameter (csi-ReportingBand) sets the value of the bit corresponding to the first subband to 3 or another value, indicating that the first subband is a subband that does not require reporting of channel state information.

By the configuration constraints of the apparatus for receiving a channel state information report, the terminal device is prevented from reporting channel state information for the first subband, thus more accurately indicating the subbands that do not require reporting of channel state information, while also saving overhead on the uplink control channel.

Manner 4: The channel state information report does not include the bits corresponding to the first subband.

The first subband is a subband whose entire frequency domain bandwidth is outside the downlink subband, or the first subband is a subband whose entire frequency domain bandwidth overlaps with the uplink subband and/or the guard band.

In one possible design of the embodiments, the terminal device does not report the channel state information of the first subband; or the channel state information report reported by the terminal device skips the bits corresponding to the first subband; or the channel state information report reported by the terminal device drops the channel state information of the first subband.

Without increasing the configuration constraints of the apparatus for receiving a channel state information report, the terminal device can ignore the indication of the first subband from the apparatus for receiving the channel state information report, thus refraining from reporting the channel state information of the first subband, making the implementation simpler.

In one possible design of the embodiments, in the case where SBFD symbols and non-SBFD symbols correspond to different CSI report configurations (CSI-ReportConfig), the channel state information report associated with the SBFD symbol is calculated based on the CSI-RS in the SBFD symbol, and the channel state information report associated with the non-SBFD symbol is calculated based on the CSI-RS in the non-SBFD symbol.

As shown in FIG. 3, for SBFD symbols, the apparatus for receiving a channel state information report knows that the uplink subbands and guard bands cannot be used for downlink scheduling. Therefore, the apparatus for receiving a channel state information report only expects to obtain the channel state information of the CSI reporting subbands that overlap with the downlink subbands, such as the channel state information for subbands #1, #2, #4, #5, and #6. For non-SBFD symbols, since the entire bandwidth can be used for downlink scheduling, the apparatus for receiving the channel state information report expects to obtain channel state information for each CSI reporting subband.

According to manner 3, the terminal device does not expect the first subband to be configured in the first configuration as the subband for which channel state information needs to be reported. Subband #3 is the first subband, meaning that the bitmap of the CSI reporting subband parameter in the first configuration may be configured as 110111. The corresponding bit value for subband #3 is 0.

According to manner 4, in the first configuration associated with the SBFD symbol, the apparatus for receiving a channel state information report may configure the bitmap for CSI reporting subband parameters as 111111. However, the terminal device does not include the bits corresponding to subband #3 in the reported CSI report, meaning that the terminal device only reports 2*5=10 bits, which correspond to subbands #1, #2, #4, #5, and #6.

In manner 3 and manner 4, for channel state information reports associated with SBFD symbols, the terminal device may only report channel state information for subbands other than the first subband, thereby saving bits for channel state information reports, reducing the load on the PUCCH, and improving transmission reliability.

Manner 5: The first configuration includes a first sub-configuration and a second sub-configuration. The first sub-configuration is associated with a first type of time-domain resource, and the second sub-configuration is associated with a second type of time-domain resource.

In one possible design of the embodiments, the channel state information report includes at least one of a first channel state information report or a second channel state information report. The first channel state information report is associated with a first type of time-domain resource, and the second channel state information report is associated with a second type of time-domain resource. The first sub-configuration is used for the terminal device to determine the subband for which channel state information needs to be reported in the first channel state information report. The second sub-configuration is used for the terminal device to determine the subband for which channel state information needs to be reported in the second channel state information report.

By way of example and not limitation, the first configuration includes a first sub-configuration (csi-reportingbandSBFD) and a second sub-configuration (csi-reportingbandNONSBFD). For instance, in the first sub-configuration, only the channel state information of subbands overlapping with the downlink subbands is indicated for reporting, while in the second sub-configuration, the channel state information of all subbands is indicated for reporting. Another example is that in the first sub-configuration, the channel state information of some of the subbands that overlap with the downlink subbands is indicated for reporting, while in the second sub-configuration, the channel state information of some subbands is indicated for reporting.

In one possible design of the embodiments, the first channel state information report is calculated based on the reference signal in the first type of time-domain resource; the second channel state information report is calculated based on the reference signal in the second type of time-domain resource.

Illustratively, as shown in FIG. 3, for subband #1, the channel state information report (the first channel state information report) associated with the SBFD symbol is calculated based on the reference signals in the SBFD symbol, for example, it can be calculated based on the CSI-RS within (C, 12), (D, 12), (E, 12), (F, 12), (C, 11), (D, 11), (E, 11), and (F, 11). The channel state information report (the second channel state information report) associated with the non-SBFD symbol is calculated based on the reference signals in the non-SBFD symbol, for example, it can be calculated based on the CSI-RS within (G, 12), (H, 12), (I, 12), (G, 11), (H, 11), and (I, 11).

In one possible design of the embodiments, the first channel state information report includes bits corresponding to the first subband.

In one possible design of the embodiments, the bit corresponding to the first subband in the first channel state information report is assigned a specified value.

By way of example and not limitation, in the case where the apparatus for receiving a channel state information report has not configured the first higher-layer parameter for the terminal device, the specified value is the first value; in the case where the apparatus for receiving a channel state information report has configured the first higher-layer parameter for the terminal device, the specified value is the second value; wherein, the first higher-layer parameter is used to indicate the number of bits corresponding to each subband in the channel state information report.

For specific implementation details, reference may be made to manner 1, which are not elaborated upon herein.

In one possible design of the embodiments, the value of the bit corresponding to the first subband in the first channel state information report is autonomously implemented by the terminal device.

For specific implementation details, reference may be made to manner 2, which are not elaborated upon herein.

In one possible design of the embodiments, in the first sub-configuration, the first subband is configured as a subband for which channel state information does not need to be reported. The first subband is a subband whose entire frequency domain bandwidth is outside the downlink subband, or the first subband is a subband whose entire frequency domain bandwidth overlaps with the uplink subband and/or guard band.

For specific implementation details, reference may be made to manner 3, which are not elaborated upon herein.

In one possible design of the embodiments, the channel state information report associated with the first type of time-domain resource does not include bits corresponding to the first subband; wherein the first subband is a subband whose entire frequency domain bandwidth is outside the downlink subband, or the first subband is a subband whose entire frequency domain bandwidth overlaps with the uplink subband and/or guard band.

For specific implementation details, reference may be made to manner 4, which are not elaborated upon herein.

Manner 5 indicates separately through two sub-configurations, reporting channel state information for different subbands for the first type of time-domain resource and the second type of time-domain resource, respectively, without increasing the complexity of processing by the terminal device.

In the aforementioned manners, each manner can be implemented individually or in combination. For example, manner 5 may be implemented in combination with manner 1 and/or manner 2, and manner 5 may also be implemented in combination with manner 3 and/or manner 4. The embodiments of the present disclosure do not impose any limitations on this, and the description is provided based on the individual implementation of each manner.

The embodiments uses one transmitting module 710 and one receiving module 720 as examples for illustration, without limiting the number of transmitting modules 710 and receiving modules 720.

For the functional introduction of the transmitting module 710, reference may be made to the content of step 510 in the embodiment shown in FIG. 5. For the functional introduction of the receiving module 720, reference may be made to the content of step 520 in the embodiment shown in FIG. 5.

FIG. 8 illustrates a schematic structural diagram of a terminal device according to some embodiments of the present disclosure. The terminal device 800 can be used to perform the method steps performed by the terminal device in the aforementioned embodiments. The terminal device 800 may include: a processor 801, a transceiver 802, and a memory 803. The processor 801 can be configured to control transmission and/or reception. The transceiver 802 can be configured to implement the functions of transmission and/or reception, such as implementing the functions of at least one of the aforementioned receiving module 610 and transmitting module 620.

The processor 801 includes one or more processing cores. By running software programs and modules, the processor 801 performs various functional applications and information processing.

The transceiver 802 may include a receiver and a transmitter, for example, which may be implemented as a single wireless communication component. This wireless communication component may include a wireless communication chip and a radio frequency (RF) antenna. The memory 803 may be connected to the processor 801 and the transceiver 802.

The memory 803 may be used to store computer programs executed by the processor, and the processor 801 is configured to execute the computer programs to implement each step in the above method embodiments.

In addition, the memory 803 may be implemented by any type of volatile or non-volatile storage device, or a combination thereof. The volatile or non-volatile storage device includes, but is not limited to: a magnetic or optical disk, an electrically erasable programmable read-only memory (EEPROM), an erasable programmable read-only memory (EPROM), a static random access memory (SRAM), a read-only memory (ROM), a magnetic memory, a flash memory, or a programmable read-only memory (PROM).

In some embodiments, the transceiver 802 is configured to receive a first configuration from a network device, wherein the first configuration is used for a terminal device to determine a subband for which channel state information needs to be reported in a channel state information report.

In some embodiments, the processor 801 is configured to report channel state information report.

For details not elaborated in the embodiments, reference may be made to the previous embodiments, which are not elaborated upon herein.

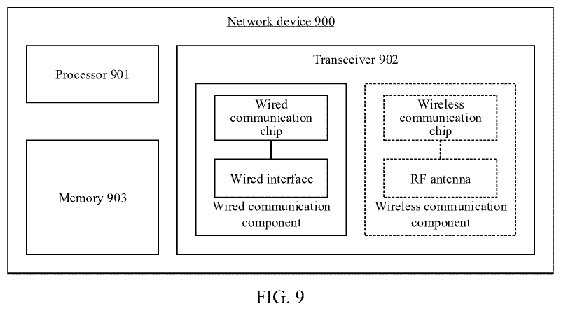

FIG. 9 illustrates a schematic structural diagram of a network device according to some embodiments of the present disclosure. The network device 900 may be configured to perform the method steps performed by the network device in the aforementioned embodiments. The network device 900 may include: a processor 901, a transceiver 902, and a memory 903. The processor 901 can be configured to control transmission and/or reception. The transceiver 902 can be configured to implement transmission and/or reception functions, such as implementing the functions of at least one of the aforementioned transmitting module 710 and receiving module 720.

The processor 901 includes one or more processing cores, and the processor 901 executes various functional applications and information processing by running software programs and modules.

The transceiver 902 may include a receiver and a transmitter. For instance, the transceiver 902 may include a wired communication component, which may include a wired communication chip and a wired interface (such as a fiber optic interface). Optionally, the transceiver 902 may also include a wireless communication component, which may include a wireless communication chip and an RF antenna.

The memory 903 may be connected to the processor 901 and the transceiver 902.

The memory 903 may be configured to store computer programs executed by the processor, and the processor 901 is configured to execute the computer programs to implement the various steps in the above method embodiments.

In addition, the memory 903 may be implemented by any type of volatile or non-volatile storage device, or a combination thereof. The volatile or non-volatile storage device includes, but is not limited to: a magnetic or optical disk, an EEPROM, an EPROM, a SRAM, a ROM, a magnetic memory, a flash memory, or a PROM.

In some embodiments, the transceiver 902 is configured to transmit a first configuration, wherein the first configuration is used for the terminal device to determine the subband for which channel state information needs to be reported in a channel state information report.

In some embodiments, the transceiver 902 is configured to receive the channel state information report.

For details not elaborated in the embodiments, reference may be made to the previous embodiments, which are not elaborated upon herein.

The embodiments of the present disclosure further provide a computer-readable storage medium, in which a computer program is stored. The computer program is configured to be executed by a processor to implement the method for reporting a channel state information report on the terminal device side as described above, or to implement the method for receiving channel state information on the network device side as described above. In some embodiments, the computer-readable storage medium may include: a ROM, a random-access memory (RAM), a solid state drives (SSD), or optical discs, etc. The RAM may include a resistance random access memory (ReRAM) and a dynamic random access memory (DRAM).

The embodiments of the present disclosure also provide a chip including programmable logic circuitry and/or one or more program instructions. The chip, when running, is caused to implement the method for reporting a channel state information report on the terminal device side or the method receiving a channel state information report on the network device side as described above.

The embodiments of the present disclosure further provide a computer program product, which includes at least one computer program stored in a computer-readable storage medium. The at least one computer program, when read from the computer-readable storage medium and executed by a processor, causes the processor to perform the method for reporting a channel state information report on the terminal device side, or the method receiving a channel state information report on the network device side.

It should be understood that the term “indication” mentioned in the embodiments of the present disclosure may be a direct indication, an indirect indication, or an indication that an associated relationship is present. For example, “A indicates B” may mean that A directly indicates B, such that B may be obtained from A; or may also mean that A indirectly indicates B, for example, A indicates C through which B may be obtained; or may mean that there is an association relationship between A and B.

In the description of embodiments of the present disclosure, the term “correspond” indicates a direct or indirect corresponding relationship between two items, or indicates an associated relationship between two items; and also indicates relationships such as indicating and being indicated, or configuring and being configured.

In some embodiments of the present disclosure, the term “predefined” may be implemented by pre-storing corresponding codes, tables, or other means that can be used to indicate relevant information in devices (e.g., including terminal devices and network devices). The present disclosure does not limit the specific implementation method. For example, the term “predefined” may refer to what is defined in a protocol.

In some embodiments of the present disclosure, the term “protocol” may refer to a standard or a protocol in the communication field, including, for example, the LTE protocol, the NR protocol, and related protocols applied in the future communication systems, which is not limited in the present disclosure.

The term “multiple” herein refers to two or more. The term “and/or” describes the association relationship between associated objects, indicating that there can be three types of relationships. For example, the phrase “A and/or B” means (A), (B), or (A and B). The character “/” generally indicates an “or” relationship between the associated objects.

The term “greater than or equal to” herein may mean greater than or equal to, or simply greater than, while the term “less than or equal to” may mean less than or equal to, or simply less than.

In addition, the step numbers described herein only exemplarily illustrate one possible execution sequence among steps. In some other embodiments, the aforementioned steps may not be executed in numerical order. For instance, two steps with different numbers may be executed simultaneously, or two steps with different numbers may be executed in a sequence opposite to the one shown in the diagram. The embodiments of the present disclosure do not impose any limitations on this.

A person skilled in the art should be aware that in the foregoing one or more examples, the functions described in the embodiments of the present disclosure may be implemented by hardware, software, firmware, or any combination thereof. The functions, when implemented by software, may be stored in a computer-readable medium or transmitted as at least one instruction or code on the computer-readable medium. The computer-readable medium includes a computer storage medium and a communication medium. The communication medium includes any medium that facilitates transfer of a computer program from one place to another. The storage medium may be any available medium accessible by a general-purpose computer or a special-purpose computer.

Described above are merely exemplary embodiments of the present disclosure and are not intended to limit the present disclosure. Any modifications, equivalent substitutions, improvements, or the like, made within the spirit and principle of the present disclosure should fall within the protection scope of the present disclosure.

1. A method for reporting a channel state information report, performed by a terminal device, the method comprising:
receiving a first configuration from a network device, wherein the first configuration is used for the terminal device to determine a subband for which channel state information needs to be reported in the channel state information report; and
reporting the channel state information report.

2. The method according to claim 1, wherein the terminal device does not expect the first subband to be configured in the first configuration as a subband for which channel state information needs to be reported;
wherein the first subband is a subband whose entire frequency domain bandwidth is outside a downlink subband, or the first subband is a subband whose entire frequency domain bandwidth overlaps with an uplink subband and/or a guard band.

3. The method according to claim 1, wherein the channel state information report does not comprise a bit corresponding to a first subband;
wherein the first subband is a subband whose entire frequency domain bandwidth is outside a downlink subband, or the first subband is a subband whose entire frequency domain bandwidth overlaps with an uplink subband and/or a guard band.

4. The method according to claim 1, wherein the first configuration comprises a first sub-configuration and a second sub-configuration, wherein the first sub-configuration is associated with a first type of time-domain resource, and the second sub-configuration is associated with a second type of time-domain resource.

5. The method according to claim 4, wherein:
the channel state information report comprises at least one of a first channel state information report and a second channel state information report, the first channel state information report being associated with the first type of time-domain resource, and the second channel state information report being associated with the second type of time-domain resource;
the first sub-configuration is used for the terminal device to determine a subband for which channel state information needs to be reported in the first channel state information report; and
the second sub-configuration is used for the terminal device to determine a subband for which channel state information needs to be reported in the second channel state information report.

6. The method according to claim 4, wherein the terminal device does not expect the first subband to be configured in the first sub-configuration as a subband for which channel state information needs to be reported;
wherein the first subband is a subband whose entire frequency domain bandwidth is outside a downlink subband, or the first subband is a subband whose entire frequency domain bandwidth overlaps with an uplink subband and/or a guard band.

7. The method according to claim 4, wherein the channel state information report comprises a first channel state information report, wherein the first channel state information report is associated with the first type of time-domain resource, and the first channel state information report does not comprise a bit corresponding to a first subband;
wherein the first subband is a subband whose entire frequency domain bandwidth is outside a downlink subband, or the first subband is a subband whose entire frequency domain bandwidth overlaps with an uplink subband and/or a guard band.

8. The method according to claim 4, wherein the first type of time-domain resource is a Subband Full Duplex (SBFD) type of time-domain resource, and the second type of time-domain resource is a non-SBFD type of time-domain resource.

9. A terminal device, comprising:
a processor; a transceiver connected to the processor; and a memory configured to store one or more executable instructions of the processor;
wherein the processor is configured to execute the one or more executable instructions to cause the terminal device to:
receive a first configuration from a network device, wherein the first configuration is used for the terminal device to determine a subband for which channel state information needs to be reported in the channel state information report; and
report the channel state information report.

10. The terminal device according to claim 9, wherein the terminal device does not expect the first subband to be configured in the first configuration as a subband for which channel state information needs to be reported;
wherein the first subband is a subband whose entire frequency domain bandwidth is outside a downlink subband, or the first subband is a subband whose entire frequency domain bandwidth overlaps with an uplink subband and/or a guard band.

11. The terminal device according to claim 9, wherein the channel state information report does not comprise a bit corresponding to a first subband;
wherein the first subband is a subband whose entire frequency domain bandwidth is outside a downlink subband, or the first subband is a subband whose entire frequency domain bandwidth overlaps with an uplink subband and/or a guard band.

12. The terminal device according to claim 9, wherein the first configuration comprises a first sub-configuration and a second sub-configuration, wherein the first sub-configuration is associated with a first type of time-domain resource, and the second sub-configuration is associated with a second type of time-domain resource.

13. The terminal device according to claim 12, wherein the terminal device does not expect the first subband to be configured in the first sub-configuration as a subband for which channel state information needs to be reported;
wherein the first subband is a subband whose entire frequency domain bandwidth is outside a downlink subband, or the first subband is a subband whose entire frequency domain bandwidth overlaps with an uplink subband and/or a guard band.

14. The terminal device according to claim 12, wherein the channel state information report comprises a first channel state information report, wherein the first channel state information report is associated with the first type of time-domain resource, and the first channel state information report does not comprise a bit corresponding to a first subband;
wherein the first subband is a subband whose entire frequency domain bandwidth is outside a downlink subband, or the first subband is a subband whose entire frequency domain bandwidth overlaps with an uplink subband and/or a guard band.

15. A network device, comprising:
a processor; a transceiver connected to the processor; and a memory configured to store one or more executable instructions of the processor;
wherein the processor is configured to execute the one or more executable instructions to cause the network device to:
transmit a first configuration, wherein the first configuration is used for a terminal device to determine a subband for which channel state information needs to be reported in the channel state information report; and
receive the channel state information report.

16. The network device according to claim 15, wherein in the first configuration, the first subband is configured as a subband for which channel state information does not need to be reported;
wherein the first subband is a subband whose entire frequency domain bandwidth is outside a downlink subband, or the first subband is a subband whose entire frequency domain bandwidth overlaps with an uplink subband and/or a guard band.

17. The network device according to claim 15, wherein the channel state information report does not comprise a bit corresponding to a first subband;
wherein the first subband is a subband whose entire frequency domain bandwidth is outside a downlink subband, or the first subband is a subband whose entire frequency domain bandwidth overlaps with an uplink subband and/or a guard band.

18. The network device according to claim 15, wherein the first configuration comprises a first sub-configuration and a second sub-configuration, wherein the first sub-configuration is associated with a first type of time-domain resource, and the second sub-configuration is associated with a second type of time-domain resource.

19. The network device according to claim 18, wherein in the first sub-configuration, the first subband is configured as a subband for which channel state information does not need to be reported;
wherein the first subband is a subband whose entire frequency domain bandwidth is outside a downlink subband, or the first subband is a subband whose entire frequency domain bandwidth overlaps with an uplink subband and/or a guard band.

20. The network device according to claim 18, wherein the channel state information report comprises a first channel state information report, wherein the first channel state information report is associated with the first type of time-domain resource, and the first channel state information report does not comprise a bit corresponding to a first subband;
wherein the first subband is a subband whose entire frequency domain bandwidth is outside a downlink subband, or the first subband is a subband whose entire frequency domain bandwidth overlaps with an uplink subband and/or a guard band.
